(19) United States
(12) Patent Application Publication
(10) Pub. No.: US 2025/0114835 A1
(43) Pub. Date: Apr. 10, 2025

(54) BENDING FIXTURE

(71) Applicant: ULTRA CLEAN HOLDINGS, INC., Hayward, CA (US)

(72) Inventors: Pavel BELOHOUBEK, Liberec (CZ); Ing. Petr SVOBODA, Liberec (CZ); Vladimir SVETINSKÝ, Liberec (CZ)

(21) Appl. No.: 18/907,970

(22) Filed: Oct. 7, 2024

Related U.S. Application Data
(60) Provisional application No. 63/588,953, filed on Oct. 9, 2023.

(51) Int. Cl. B21D 9/12; B21D 9/18

(52) U.S. Cl. CPC B21D 9/12; B21D 9/18

(57) ABSTRACT

A system for imposing a permanent bend in a length of tubing, includes a bend setting portion having surface, a groove extending inwardly of the surface, the groove having a dimension which is smaller than an outer dimension of a tubing to be bent therein a fixing element extendable to secure a tubing in the groove, and a heater configured to heat the bend setting portion to a fixing temperature.

### CROSS-REFERENCE TO RELATED APPLICATIONS

This application claims benefit of U.S. provisional patent application Ser. No. 63/588,953, filed Oct. 9, 2023, which is herein incorporated by reference.

### BACKGROUND OF THE DISCLOSURE

### Field of the Disclosure

The disclosure hereof is related to the field of the fabrication of non-ferrous bent tubings and to the tubings themselves which are used to connect fluid sources and use locations, such as a first fluid flow connector or fitting connected to a source of a fluid, and a second fluid flow connector or fitting fluidly connected to, for example, a component using or controlling the fluid, or other fluid connections or fittings, where the tubing extending between the connectors or connections (fitting or fittings) must be bent from a generally straight line configuration to a bent configuration in order to interconnect the opposed ends of the tubing to different fluid connections. The disclosure hereof is further directed to the field of bending of such tubing to form a permanent bend therein while minimizing the generation of particles in the interior thereof.

### Description of the Related Art

Non-ferrous tubing includes tubings such as those composed of PFA (perfluoroalkoxy alkanes), wherein the tubing includes a circumferential wall having a defined thickness which surrounds an interior flow conduit, the interior flow conduit extending between opposed ends. A length of PFA tubing is commonly used to fluidly connect two fluid components, for example by connection to a fluid fitting on each of the fluid components, in a fluid tight or sealed manner. For example, the opposed ends of the tubing are configured to include a fitting thereon, which fitting connects in a sealed manner to a mating fitting on another fluid component.

PFA tubing, although flexible, is commonly configured from the a straight-line configuration thereof to include bends therein to route the tubing so that the ends thereof are located such that they may be readily connected to mating fittings. The tubing material is commonly supplied in straight lengths, which are then cut to a desired length and bent into the desired use configuration. A single length of bent tubing can include one or more bends therein. For example, the tubing may be used within an enclosure within which fluid connection locations including fittings are located in specified locations in three-dimensional space. The tubing is bent to configure the tubing such that when located within the enclosure for connection of the opposed ends thereof to mating fittings, the ends, and the fittings thereon are located to directly face the mating fittings and connect thereto with minimal distortion to the bent configuration of the tubing. Additionally, the bent configuration of the tool is designed such that the physical location of the bent tubing does not interfere with other items in the enclosure, for example other fittings to which the bent tubing is not to be connected, and other tubings in the enclosure.

Materials such as a PFA material may be worked to change their shape by heating the material to a setting temperature, imposing a new shape on the material, and then cooling the material while the new shape is physically maintained on the material. The current methodology for fabrication of bent tubings of, for example, PFA from a length of straight tubing of PFA includes inserting rods, having an outer diameter nearly as large as the inner diameter of the tubing to be bent, inwardly of the opposed ends of the tubing and thus into the interior flow conduit of the tubing, bending the tubing to the desired bent configuration using the rods, heating the tubing with the rod(s) therein to a setting temperature where, after cooling, the tubing will retain the bent shape if it is held in the bent configuration while it is cooled, and cooling the bent tubing to below a setting temperature. The opposed rods sticking outwardly of the ends of the tubing, or portions thereof, are held in a technician's hand and actuated to bend the tubing into a desired shape, and a heat source, such as a heat gun or propane torch, is used to locally apply heat to the bent portion to cause the bent portion to reach the setting temperature of the tubing material, after which the bent heated tube is held in the bent configuration until the tube cools to a temperature sufficiently low to maintain the bend therein. However, this tube bending methodology leads to a number of issues. Firstly, the bend itself and the lengths of the straight tubings extending from opposed ends of the bend are variable from bent tubing to bent tubing, because the bending is performed in free space. Additionally, the use of the rods and the rubbing thereof against the inner surfaces of the flow conduit of the tubing leads to the generation of particles in the flow conduit. Because the tubings are often used in ultra cleanliness applications, such as for the flow of gases or liquids used in the formation of film layers used for semiconductor device production, the presence of these particles is problematic and they must be removed before the tubing is used in such applications.

One methodology which has been used to remove these particles is to blow clean dry air through the flow conduit of the tubing. However, this removes some of the particles, but portions of the particles become free in the flow of the clean dry air and redeposit on the interior wall of the tubing, or on other surfaces exterior of the tubing, where they can find their way onto, or within the flow conduit of, the same or later fabricated and processed tubings. Additionally, the contact of the rod with the inner surface of the surrounding tubing wall can damage the inner tubing wall, leading to cracking or pinhole leaks in the tubing.

### SUMMARY OF THE DISCLOSURE

A system for imposing a permanent bend in a length of heat fixable tubing includes a bend setting portion having surface, a groove extending inwardly of the surface, the groove having a dimension which is smaller than an outer dimension of a tubing to be bent therein, a fixing element extendable to secure a tubing in the groove, a heater configured to heat the bend setting portion to a fixing temperature.

The heat fixable tubing can have a fixed bend placed therein by providing a bend setting portion having surface, providing groove extending inwardly of the surface, the groove having at least one curve therein, providing a fixing element extendable to secure a tubing in the groove, pressing a length of tubing inwardly of the groove such that the tubing has the contour of the curve in the curve imposed on at least a portion thereof, heating the bend setting portion having the tubing therein to a setting temperature of the material thereof, and cooling the bend setting portion with the tubing and removing the tubing from the bend setting portion, wherein the curve of the groove remains in the tubing after the tubing is removed from the bend setting portion.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1A is a view of a length of tubing prior to having a bend imposed therein;

FIG. 1B is the length of tubing of FIG. 1A, after having a bend imposed therein;

FIG. 1C is the length of tubing of FIG. 1A after having a bend, different from that of FIG. 1B, set therein;

FIG. 1D is the length of tubing of FIG. 1A after having a bend, different from that of FIGS. 1B and 1C, set therein;

FIG. 2 is a view of a bending fixture useful to impose a bend on a length of heat fixable tubing;

FIG. 3 is a sectional view of the bending fixture of FIG. 2 at section 3-3 thereof, showing a tubing in a configured groove of the bending fixture and a fixing portion or clamp extending into the groove and contacting a tubing in the groove;

FIG. 4A is a schematic view of a temperature setting apparatus for heating and cooling the bending fixture, with a length of tubing therein;

FIG. 4B is a schematic view of a temperature setting apparatus for heating and cooling the bending fixture, with a length of tubing therein;

FIG. 5 is a view of an end of the tubing of FIG. 1 showing a plug to be received in the end;

FIG. 5A is a view of an end portion of the plug of FIG. 5;

FIG. 6 is a view of a suspension apparatus for holding the bend setting portion in a heating apparatus; and

FIG. 7 is a schematic side view of a bend setting portion holding and heating apparatus.

### DETAILED DESCRIPTION

Herein, tubing is configured to include one or more bends therein by placing the tubing into a fixture, heating the tubing in the fixture to the setting temperature of the tubing material, and cooling the tubing to leave a bend remaining in situ in the tubing after the tubing is cooled. The fixture may be independently heated to heat the tubing in the fixture with the bend imposed thereon to a temperature to allow the tubing, when cooled, to retain the bend therein, in other words, to a setting temperature, or the fixture may be located in an oven or furnace and heated to a setting temperature of the tubing restrained in a bent configuration therein, and removed therefrom to allow the fixture and tubing to cool such that the bend remains therein after cooling. The fixture, and thus the tubing, may be also actively cooled, to set the bend in the tubing.

In one aspect, a temperature maintenance system is provided which includes a heated area, hereafter referred to as an oven, and a cooled portion, hereinafter the cooing region, the interior volumes of which are in fluid communication with one another. The tubing is loaded into the fixture to constrain the tubing in a bent configuration at room, or a non-actively heated, temperature, where the fixture can be handled without special precautions to prevent burning of the skin of an operator. The fixture includes a channel having the final bent configuration of the tubing extending inwardly of a side thereof, into which the tubing can be inserted and constrained. The fixture is loaded into the oven, and maintained therein for a time period required to bring the tubing to the setting temperature and maintain the tubing at the setting temperature a sufficient time to allow a permanent bend to be imposed in the tubing after it is cooled. The fixture is then moved to the cooling region, where the fixture and tubing are brought back to a safe handing temperature, for example room temperature, while the tubing is restrained therein in the bent configuration. The tubing is then removed from the fixture, with the bend retained therein.

The use of a fixture to heat and cool the tubing allows the interior flow conduit of the tubing to be protected while the bend is being imposed or permanently set into the tubing, and a desired series of tubing intended to have identical configurations of bend and straight portions extending therefrom can be configured. Additionally, by using a fixture, tubings having compound bends where two or more bends or a continuous bend with different radii or different bend directions at different locations along the length of the tubing can be prepared.

Here, in one aspect, the fixture is a rigid metal plate having sufficient dimensional stability when heated to the tube material setting temperature to hold the tubing therein in the desired bent shape while the tube remains at the setting temperature and is thereafter cooled. For example, the fixture here, in one aspect, includes an aluminum plate having a slot cut into one surface side thereof, which slot includes at least a first straight portion, a second straight portion, and a curved or bent portion. The tubing to be bent into the shape of the groove is pressed into the groove, which is exposed at the one surface side of the fixture, while the fixture is at a temperature where it can be safely handled by a person. The fixture, with the tubing therein, is then heated, for example by the placement thereof into an oven or furnace, to increase the temperature of the tubing to the setting temperature. Thereafter, the fixture and tubing are cooled, for example by simply removing the fixture from the oven or furnace and letting the fixture cool to the surrounding ambient temperature, or by moving the fixture with the tubing therein to an active cooling region.

Herein, the tubing into which a permanent bend is to be created is flexible, but unless the tubing is heated to the setting temperature thereof and then cooled, the bend in the tubing, when the force holding the tube in the bent configuration is released, will actuate back to the unbent configuration of the tubing prior to the bend being imposed thereon. By holding the tubing in the desired bent configuration, heating it to its setting temperature whereby cooling of the tubing will result in the bend being set therein, results in a bent length of tubing.

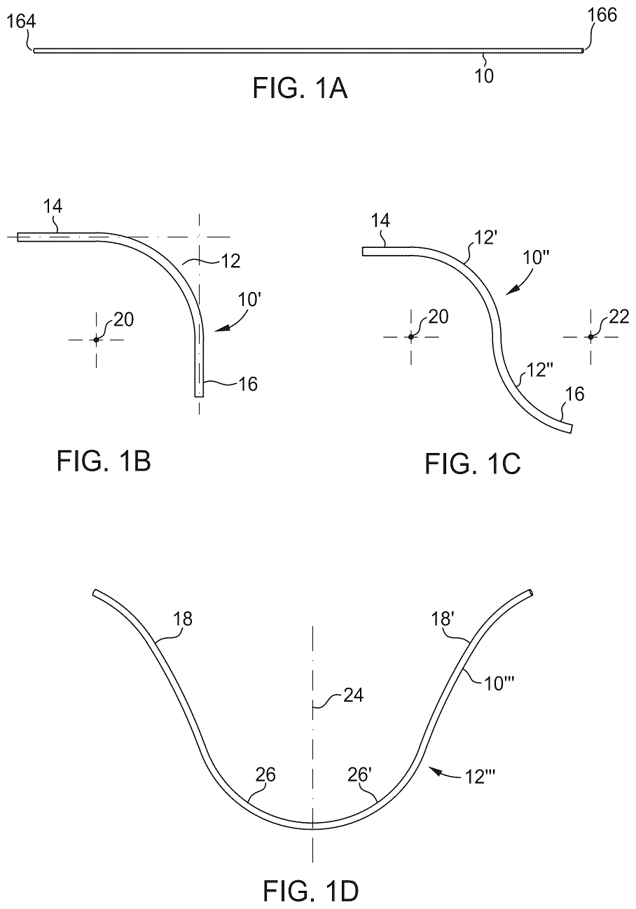

Referring to FIG. 1A, there is shown a length of straight tubing 10 prior to being bent, and in FIG. 1B the tubing has been bent to form a bent tubing 10′ including a right angle bend having a curved portion 12 from which opposed straight portions 14, 16 extend. The centerlines of the straight portions 14, 16 here cross at a right angle, and the center of the flow conduit 22 of the curved portion 12 extends at a single radius centered at center point of bend 20.

Referring to FIG. 1C, the straight length of tubing has been bent in a single bending operation, as will be described herein, to include a compound curved bent tubing 10″. Here, the opposed straight ends of the tubing extend from different bent portions of the tubing, here a first curved portion 12′ extending a long a single radius from center point 20, and a second curved portion extending along a single radius from a second center point 22, but bent so that the ends of the second curved portion do not extend 90 degrees part. Here the curved portions 12′, 22, are curved in opposing direction.

Referring to FIG. 1D, there is shown the length of tubing 10 prior to having a bend imposed thereon (FIG. 1A) after a permanent compound bend 12 is imposed thereinto. Here, using the perspective of an axis of symmetry 14, the compound bend of the bent tubing includes first and second concave portions 16, 16′ which are “mirror” bends about axis of symmetry 14, and first and second convex bends 18, 18′, which likewise are “mirror” bends about axis of symmetry 14. The contours of the bent tubings of FIGS. 1B to 1D are shown for demonstration purposes only, and are not intended as indicative the only bends that can be created in tubing using the methodologies and equipment described herein. Here, the tubing 10 is composed of PFA, but the methodologies and equipment described herein can be used to create lasting bends in tubing configured of other materials where heating of the tubing while constrained in a bent shape, followed by cooling of the tubing, results in a lasting or permanent bend in the tubing, it being understood that reheating the tubing can allow the removal of the bend therefrom or the imposition of a different bend therein.

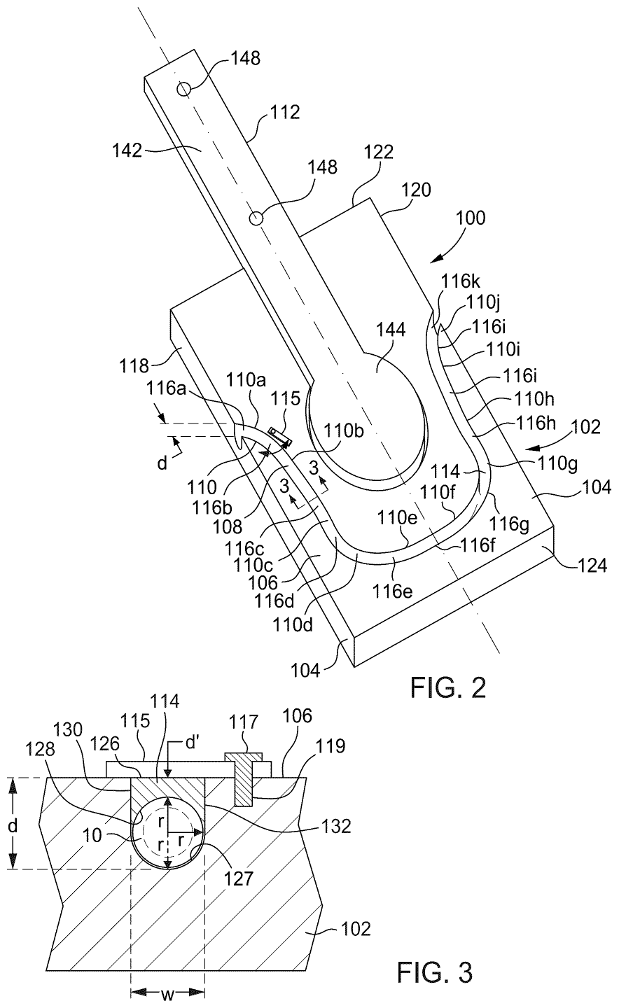

Referring initially to FIG. 2, there is shown a bending fixture 100 configured to create or form one or more bends in a length of tubing, for example tubing composed of PFA, to impose the bent shape of the bent tubing 10″ of FIG. 1D therein. Here, bending fixture 100 includes a bend setting portion 102 comprising a generally flat or planar, plate like portion 104, having a loading surface 106, a contoured groove 108 extending inwardly of the loading surface 106 and having at least one curved portion 110 therein, and a handle portion 112 extending from the plate like bend setting portion 102. A safety clamp 114, here having a profile or configuration in the shape of the contoured groove 108, an upper surface 126 and a tubing facing surface 128, is configured to be fit over and inwardly of at least a portion of the contoured groove 108. For example, in use, a length of straight tubing is bent and pushed inwardly of the contoured groove 108, and then the safety clamp 114 is pushed into the groove over the length of tubing therein. Thus, the safety clamp 114 is configured to be pressed into the contoured groove 108 after a length of tubing 10 has been pushed thereinto, to hold the tubing 10 in the shape of the contoured groove 108 and radially inwardly compress the portion of the outer surface thereof in contact therewith. One or more locking pins 115, configured to swing about a pivot pin 117 secured in a bore 119 extending inwardly of the flat plate like portion 104 can be provided to swing over the outer surface of the safety clamp 114 to secure it in the contoured groove 108. Alternatively, a cover plate, or simply the locking pins 115 pivotable about one end thereof to enable their movement to have them span the contoured groove 108 with the tubing 10 therein, but moveable to clear access to the contoured groove 108 for placement and removal of the bent tubing 10″ with respect thereto, can be used to retain the tubing 10 prior to reaching the setting temperature, and the bent tubing 10″ as it cools from the setting temperature to a safe handling temperature thereof, in the contoured groove 108.

Bend setting portion 102 here is a generally flat plate, rectangular in plan view (FIG. 2) having opposed first and second major sides 118, 120 extending along opposed sides of the rectangular in the longer length dimension of the rectangle, and opposed minor first and second sides 122, 124 connecting to the first and second major sides 118, 120 at opposed ends thereof. The bend setting portion 102 has a thickness greater than the diameter of a piece of tubing which will be loaded into the contoured groove 108 thereof, for example 1.5 or more times the diameter of a one or more lengths of tubing which will be loaded into the contoured groove 108 thereof. The contoured groove 108 has a width w slightly smaller than, on the order of less than or equal to 5% smaller than, i.e., greater than 0% and up to 5% than, the outer diameter of a tubing to be fitted therein to form a permanent bend therein. By configuring the width w of the contoured groove 108 to be smaller than the outer diameter of the tubing 10, the tubing can be compressed when in the contoured groove 108. Additionally, the inner surface of the contoured groove 108 can be configured to be semi-circular or nearly semi-circular in cross section over its length, to lie along radius r which is one-half the width w. When the safety clamp 114 is pushed into the contoured groove 108 over a length of tubing 10 therein, and pins 115 are deployed to hold it in place within the contoured groove, the semi-circular surfaces thereof, when used, surround the tubing 10 and compress it radially inwardly against the base of the contoured groove 108. Here, the material of the bend setting portion 102 is a metal capable of withstanding the temperature at which the tubing must be elevated to cause the bend to set therein, for example a metal such as aluminum. Aluminum provides sufficient dimensional stability between an ambient temperature on the order or 20 degrees Celsius and the bend setting temperature on the order of 220 degrees Celsius, and is easily machinable with a mill using a milling machine to cut the contoured groove 108 into the loading surface 106 side thereof. Other materials capable of maintaining dimensional stability when exposed to the setting temperature of the tubing material can also be used for the bend setting portion 102.

In FIG. 2, the contoured groove 108 is shown extending between opposed first and second major sides 116, 118 of the bend-setting portion 102 of the bending fixture 100 and includes a plurality of curved portions 110 and a plurality of straight portions 116 therein. Here, the bends 110a to 110j are interposed between adjacent lengths of straight portions 116a to 116k of the contoured groove 108. For example, straight portions 116a and 116b extend from opposed ends of curved portion 110a, straight portions 116b, 1116c extend from opposed sides of curved portion 110b, etc. Here, one end of straight portion 110a opens into first major side 118 of the bend setting portion 102, and one end of the last straight portion 116k opens into second major side 120 of the bend setting portion. The contoured groove has a width w slightly smaller than, on the order of less than or equal to 5% smaller than, the outer diameter of length of tubing to be fitted therein to form a permanent bend therein. The depth d of the contoured groove 108 can be slightly less, to greater than, the diameter of the tubing to be fitted therein to form a permanent bend therein. Where the clamp 114 is used, the depth d of the contoured groove is greater than the outer diameter of the tubing 10 to be processed therein, as will be described herein. In FIG. 2, the contoured groove 108 is configured to form a U shaped length of a groove comprising a number of small bends, which together will form a continuous U shaped bent tubing having the compound U-shaped bend profile of FIG. 1D. However, any number of bends can be imposed into a length of tubing using a bending fixture having the appropriately contoured or shaped contoured groove 108. For example the contoured groove 108 can be configured as a single right or other degrees of angle bend to form a bent tubing 10′ as shown in FIG. 1B, multiple such bends as shown in the bent tubing 10″ of FIG. 1C, bends with lengths of straight portions therebetween, or other configurations as desired for the final configuration of the bent tubing 10′.

Here, clamp 114 is provided to be located over at least a portion of the length of tubing positioned within the contoured groove. Thus, here clamp 114 is a length of a relatively stiff material having a similar coefficient of thermal expansion as that of the bend setting portion 102, for example, both the clamp 114 and the bend setting portion 102 may be configured of aluminum. Here the clamp 114 has a generally flat or planar upper outer surface 126 facing in a direction away from a curved inner tubing contacting surface 128, and opposed side surfaces 130, 132. Here, curved tubing contacting surface 128 lies on a same radius r as the radius of the inner surfaces of the contoured groove 108 to contact and radially inwardly compress the outer surface of a tubing 10 when received in the contoured groove 108 and outer surface 128 is held coplanar with the loading surface 106. Curved tubing contacting surface 128, in section, extends nearly or fully the length of a semi-circle over its length. Clamp 114 is configured to compress the tubing 160 in the contoured groove, when the flat outer surface 126 is flush or co-planar with the loading surface 106. Because the curved tubing contacting surface 128 is semicircular section, and the curved inner surface 127 of the contoured groove, in section, likewise extends nearly all or all of a semicircle (180 degrees), the outer surface of the tubing 10 is contacted over all, or nearly all, of its circumference over the full length thereof disposed in the contoured groove. The narrowest depth d′ of the clamp 114, in other words, the thickness of the smallest thickness portion of the clamp 114 is sized to ensure that the portion of the tubing 10 contacting the semi-circular surface of the clamp will be under compression, so that the tubing 10 is radially compressed over its circumference.

By maintaining the tubing 10 in a radially compressed state throughout the bent portion thereof, the tubing 10 can be fabricating into a tubing having a bend therein that is not ovoid in section, and the inner flow conduit will maintain the circular or nearly circular, in section profile as the rest of the tubing extending from the ends of the bend. In contrast, where the tubing is not constrained or compressed when bent, the outer wall furthest from the radius of the bend will tend to flatten radially inwardly, and the wall closes to the radius of the bend can move away from the radius (move inwardly of the tubing), resulting in an ovoid cross section which can disturb the desired flow characteristics of the internal flow conduit of the tubing.

Here, handle portion 112 extends from the bend setting portion 102 and includes an extending bar 142 and a connecting portion 144, the connecting portion 144 connecting the handle portion 142 to the bend setting portion 102. Connecting portion 144 includes a boss (not shown) extending therefrom and into a corresponding boss recess (not shown) extending inwardly of the loading face 102. The handle portion 112 is thereby secured within the boss recess to allow a user to manipulate the device having a tubing inserted within the contoured groove 102 into an oven or furnace, and after heating, to a cooling region. Connecting portion 144 can be a fixed connection, such that the orientation of the handle portion 112 to the bend setting portion 102 is fixed, or a pivot or hinged connection.

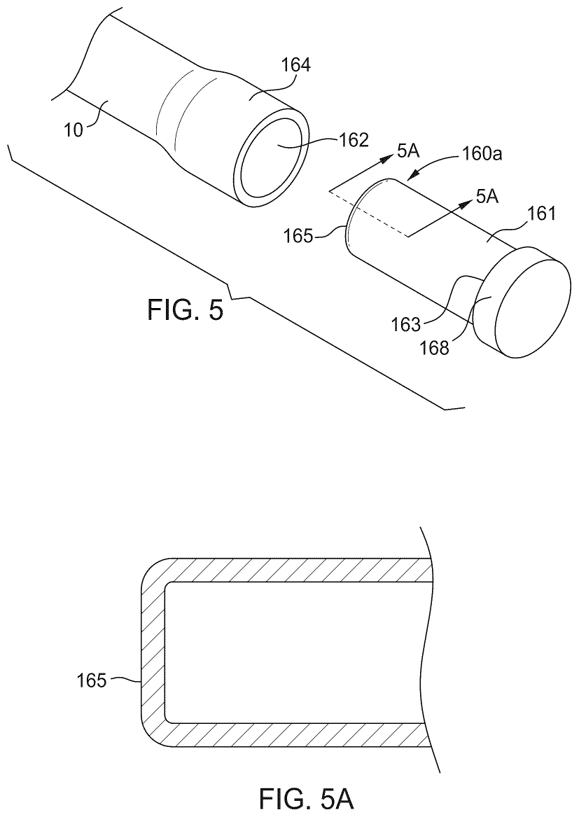

Here, the bending of the tubing is discussed with respect to the placement of a U-shaped bend into the length of tubing. To bend a length of straight tubing 10 of FIG. 1A into a length of bent tubing 162 of FIG. 1D having a permanent U-shaped bend therein, the length of straight tubing 10 is removed from its packaging in a clean environment such as a clean room, and the opposed first and second tubing ends 164, 166 are sealed with a fitting or plug 160a (likewise removed from its packaging in the clean environment) to prevent any particulates in the ambient surroundings from getting inside the central flow conduit of the tubing 160 as shown in FIG. 5. In FIG. 5, the plug 160a includes a generally cylindrical extending portion 161 having a solid end wall 165 (FIG. 5A) facing the open end of the tubing 10, and an enlarged handling portion 168 at the end of the extending portion 161 opposed to the solid end wall, such that a raised circumferential limit ledge 163 is formed at the juncture of the extending portion 161 and the handling portion 168. The circumferential limit ledge 163 defines the limit or extent to which a tubing 10 can extend over the extending portion 168. The extending portion is thus inserted into the first end 164 of the tubing 10 and the second end 166 of the tubing 10 to seal the interior flow volume of the tubing 10 off from the ambient environment. The tubing 10 is then pressed into the contoured groove 108 and clamped in place, such as with safety clamp 114.

In one aspect hereof, the tubing and fixture may be preheated to a temperature near but below the setting temperature of the tubing material, which for PFA material is 220 degrees Celsius, before being heated to the setting temperature. For example, the bending fixture 100 and tubing 10 therein can be heated on a hot plate or a pre baking oven to a temperature of, for example, 160 degrees Celsius or greater, for example 180 degrees Celsius. Preheating the bending portion 102 (and the tubing 10) reduces the amount of time the tubing 10 and bending portion 102 remains in the bend setting oven or furnace to be heated to the setting temperature.

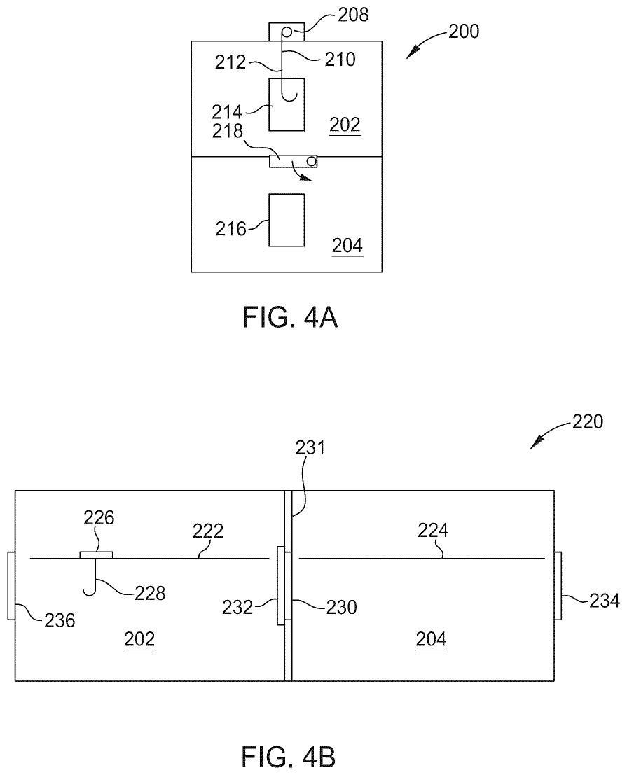

The bending fixture 100 with the tubing 10 therein is then loaded into a bend setting furnace or oven, here heating and cooling apparatus 200 (FIG. 4A) which provides a heated volume 202 capable of heating the 102 to the setting temperature, and a cooling volume 204 providing an actively cooled cooling region. Cooling volume 204 is here located immediately adjacent, in this case below, oven 200, and the interiors thereof can be communicable with one another through a door 218 to move a heated bending fixture 100 having a length of tubing 160 that has been heated to the bend fixing temperature from the oven 200 to the cooling volume 204. For example, a hand or motor powered winch 208 can be located over the outer top side of the heated volume 202, and include a cable 210 extending therefrom terminating in a support fixture, for example a hook shaped structure 214. The handle portion 148 can be secured to the hook shaped structure 214. After the fixture has been heated to the setting temperature and the tubing therein allowed to reach the setting temperature for a desired period of time, a door 218 between the heating volume 202 and cooling volume 204 can be opened, and the winch 208 actuated to lower the bend setting portion 102 into the cooling volume. Here, an heated portion 214 is provided for the heated volume to load an bend setting portion 102 into the heated volume 202, and a separate cool side door 216 is coupled to the cooling volume to allow removal of the bend setting portion from the cooling volume 202.

Alternatively, an inline heating and cooling apparatus 220 can be provided, wherein the heated volume 202 and cooling volume are side by side, and a wall having a selectively openable pass through door 230 is provided. Here, the door can slide along the side of the separating wall to open an opening between the heated volume 202 and the cooling volume. A hanging fixture 226 having a hook shaped support 228 is suspended from a first moving track 222 (shown schematically), and the handle portion of a bend setting portion 102 can be secured thereto in the heated volume. The first moving track 222 can move the hanging fixture 116, with the bend setting portion 102 suspended therefrom, along the track from sealable hot ide access door 232 to the pass through door 230. With the pass through door 230 open, further movement of the first moving track will cause the hanging fixture 226 to become suspended to a second moving track 224, which will move the hanging fixture 226 and the bend setting portion thereof in the direction of the cool side door 234.

The length of the first moving track 226 and its speed of movement of the hanging fixture 226 in the horizontal direction, are selected to allow the bend setting portion 102 and any tubing therein reach the setting temperature of the tubing and keep the tubing at that setting temperature in the heated volume 202 a desired, user selected period of time, before the hanging fixture moves from the location adjacent the hot side door 232 to the pass through door 230, at which time the pass through door opens and the hanging fixture 226 with the bend setting portion 102 suspended therefrom enters the cooling portion 204. Likewise the length of the first moving track and its speed of movement of the hanging fixture 226 in the horizontal direction, are selected to allow the bend setting portion 102 and any tubing therein reach the desired cooled removal temperature in the cooled volume before the hanging fixture is move to adjacent the cool side door 234. Here, the heated volume is actively cooled, using infrared heaters, hot forced air heating, hot plates or heating blankets surrounding the heated volume 202, or the like. The cooling volume can be actively cooled using forced air cooling or a set of surrounding chilling fluid passages, or simply b flowing ambient air at the surrounding ambient temperature of the cooling volume through the cooling volume 202.

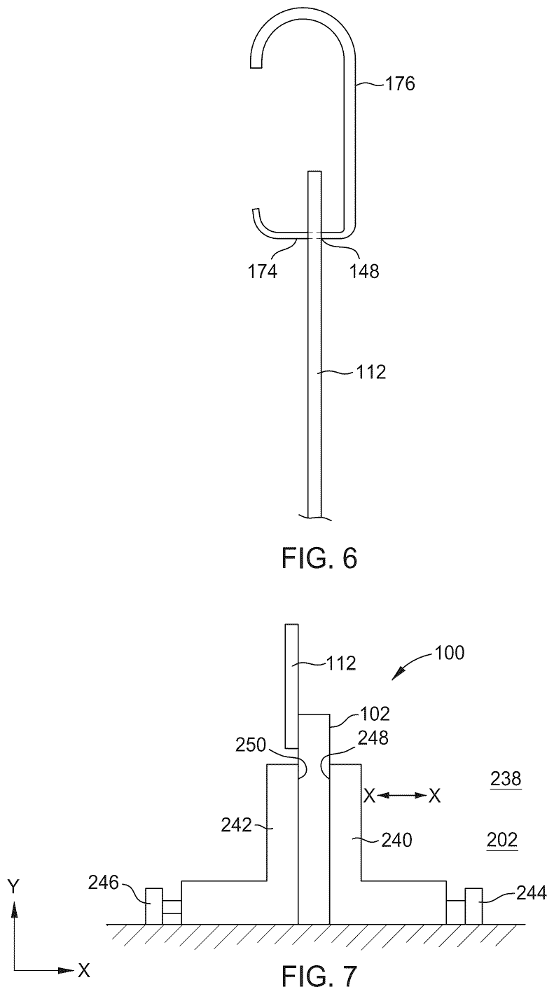

The bend setting fixture 102 may also be manually loaded into and out of a furnace or oven. Here, to suspend the bend setting portion 102 in the oven for example, as shown in FIG. 6, the extending bar portion of the handle portion 112 includes one or more through holes 148 extending therethrough, into which a first pin 174 from a first suspension member 176 can be received to connect the suspension member 176 to the extending bar portion 142, and thus to the bend setting portion 102. The suspension member 176 is then connected, such as by a hook thereon, to a mating surface in the oven above. The bend setting portion 102 is then heated to the tubing fixing temperature to heat the tubing therein to the fixing temperature thereof, and maintained at that temperature in the oven a desired setting time. Thereafter, an operator accesses the interior of the oven such as through a sealable door, to remove the fixture bend setting fixture 100, and the bend setting fixture is allowed to cool in the ambient environment. The tubing 10, with the bend set therein, is then removed.

In each of above bend setting portion heating and cooling scenarios, the bending fixture 100 including the bend setting portion 102 may be cleaned before it is reused to place a bend in another piece of tubing, or simply loaded with another length of tubing 10 into which a bend will be permanently imposed.

As shown in FIG. 7, an oven for heating the bending fixture 100 with a tubing in the bend setting portion 102 thereof, can include therein a loading fixture to hold the bend setting portion 102 and fixing portion, such as clamp 114, together, and provide a heated mass, which can transfer heat energy into the bend setting portion and fixing portion in the oven 200. Here, pins 115 need not be used to hold clamp 114 in place in the contoured groove 108, and opposed first and second ram plates 210, 212, at least one of which is moveable in the X direction of FIG. 7, are provided to clamp against both sides of the bend setting portion 102, and thus ensure the clamp 114 is properly positioned within the contoured groove 108. Here, the relative spacing of the first and second ram plates 210, 212 with respect to each other is controlled by the actuation of a least a first ram mover 214 operatively connected to first ram plate 210. A second ram mover 216 may be provided connected to second ram mover 216. By increasing the spacing between the facing first and second planar surfaces 218, 220 of the first and second ram plates 210, 212 respectively, in the X direction, the bend setting portion 102 can be released from between the first and second ram plates 210, 212 and can be removed from the oven 200. The bend setting portion 102 with a tubing 10 and clamp 114 therein can be placed in the space between the first and second ram plates 210, 212, after which the first (and if provided) second ram movers 214, 216 activated to move the opposed first and second planar surfaces 218, 220 towards each other in the X direction thereby ensuring the clamp 114 is properly seated in the contoured groove 108 and also enable transfer by conduction of heat from the first and second ram plates 210, 214 into the bend setting portion 102 and the clamp 114 and thus into the tubing 10 held therebetween. Here, first and when provided second ram movers 214, 216, can be fluid operated pistons, lead screw arrangements, or other devices capable of moving the first and second planar surfaces 218, 220 toward and away from each other as desired to load, hold, and release the bending fixture 100.

Herein, for each tubing diameter and each bend type, a different bending fixture 10, having a groove of the desired width and depth to allow the tubing to be radially inwardly compressed during the bending process, and having the desired bend profile, is provided for each specific tubing 10 outer diameter and final bent tubing 10′ configuration. Additionally, although the contoured groove 108, and clamp 114, are described as having semicircular surfaces contacting the tubing, where the tubing is not circular in section, the tubing contacting surfaces need not be semi-circular. For example, if the tubing is rectangular in section, the base of the contoured groove 108, and the inwardly facing surface of the clamp 114, can be flat surfaces, which, when the clamp 114 is pressed into the contoured groove over a length of rectangular in section tubing, are parallel to one another and spaced apart by less than the free span of the tubing in the direction between the facing parallel surfaces. Likewise, the opposed sides of the contoured groove can be spaced apart by less than the width of the rectangular in section tubing placed thereinto. Such that the tubing will be compressed inwardly of the groove. In other tubing, in section, configurations, the groove and clamp can be configured to ensure inwardly compression of the tubing therein, if desired.

1. A system for imposing a permanent bend in a length of heat fixable tubing, comprising;
a bend setting portion having surface;
a groove extending inwardly of the surface, the groove having a dimension that is smaller than an outer dimension of a tubing to be bent therein;
a fixing element extendable to secure a tubing in the groove; and
a heater configured to heat the bend setting portion to a fixing temperature.

2. The system of claim 1, wherein the fixing element further comprises a clamp extending inwardly of the groove.

3. The system of 2, wherein the groove comprises;
an opening in the surface of the bend setting portion;
opposed side walls extending inwardly of the surface of the bend setting portion; and
a first curved surface located inwardly of the groove and facing the opening and connecting to opposed inward ends of the opposed sidewalls.

4. The system of claim 3, wherein the fixing element includes a second curved surface, which, when located in the groove, faces the first curved surface.

5. The system of claim 4, wherein the fixing portion includes a generally first flat plane surface on the side thereof opposed to the curved surface;
the surface of the bend setting portion comprises a second flat plane surface; and
the first flat plane surface of the fixing portion is configured to rest coplanar to the second flat plane surface when the fixing portion is located in the grove and in contact with a tubing therein.

6. The system of claim 5, wherein the first curved surface and the second curved surface are partial circles, and each has the same radius.

7. The system of claim 6, wherein the first curved surface and second curved surface are configured to contact a tubing in the groove substantially over its circumference.

8. The system of claim 7, wherein the distance between the second curved surface and the second plane surface of the fixing portion is configured such that the second curved surface and the first curved surface together radially inwardly compress a tubing.

9. The system of claim 1, further comprising a plug receivable in an open end of a tubing.

10. The system of claim 1, further comprising an active cooling volume.

11. A method of bending a heat fixable tubing, comprising:
providing a bend setting portion having surface;
providing groove extending inwardly of the surface, the groove having at least one curve therein;
providing a fixing element extendable to secure a tubing in the groove; pressing a length of tubing inwardly of the groove such that the tubing has the contour of the curve in the curve imposed on at least a portion thereof;
heating the bend setting portion having the tubing therein to a setting temperature of the material thereof; and
cooling the bend setting portion with the tubing and removing the tubing from the bend setting portion, wherein the curve of the groove remains in the tubing after the tubing is removed from the bend setting portion.

12. The method of claim 11, wherein the heating of the bend setting portion having the tubing therein to a setting temperature of the material thereof comprises placing the bend setting portion with the tubing therein in an oven configured to heat the bend setting portion and tubing therein to the setting temperature.

13. The method of claim 12, wherein, prior to heating the bend setting portion to the setting temperature, the bend setting portion is heated to a temperature between the local ambient temperature and the fixing temperature.

14. The method of claim 11, wherein, prior to heating the tubing to the setting temperature, the tubing is heated to a temperature between the local ambient temperature and the fixing temperature.

15. The method of claim 11, wherein the cooling of the tubing is performed in a cooling volume.

16. The method of claim 11, further comprising plugging the open ends of the tubing with plugs prior to placing the tubing in the groove of the bend setting portion.

17. The method of claim 16, wherein the tubing comprises PFA.

18. The method of claim 11, wherein the fixing element includes a first surface extending inwardly of the groove and in contact with the tubing in the groove.

19. The method of claim 18, wherein the first surface is a semi-circular surface, and the groove includes a second semi-circular surface which faces the first semicircular surface when the fixing portion extends inwardly of the groove.

20. The method of claim 19, wherein the first surface and the second surface radially inwardly compress the tubing in the groove.
